(19) United States
(12) Patent Application Publication
(10) Pub. No.: US 2026/0219958 A1
(43) Pub. Date: Jul. 30, 2026

(54) Processor Environment Agnostic Firmware Management Operation Including a Dynamic Workload Management Operation

(71) Applicant: Dell Products L.P., Round Rock, TX (US)

(72) Inventors: Harish Barigi, Nellore (IN); Shekar Babu Suryanarayana, Bangalore (IN)

(21) Appl. No.: 19/038,068

(22) Filed: Jan. 27, 2025

(51) Int. Cl. G06F 9/50

(52) U.S. Cl. CPC G06F 9/5083; G06F 9/5033; G06F 9/505

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a dynamic workload management operation, the dynamic workload management operation managing a workload executing on the information handling system, the dynamic workload management operation being processor environment agnostic.

### BACKGROUND OF THE INVENTION

### Field Of The Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a dynamic workload management operation, the dynamic workload management operation managing a workload executing on the information handling system, the dynamic workload management operation being processor environment agnostic.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed unified BIOS; identifying a processor environment installed on an information handling system from a plurality of processor environments, the processor environment comprising a processor architecture; and, performing a dynamic workload management operation, the dynamic workload management operation managing a workload executing on the information handling system, the dynamic workload management operation being processor environment agnostic.

In another embodiment the invention relates to a computer-readable storage medium embodying computer program code, the computer program code comprising computer executable instructions configured for: providing an information handling system with a distributed unified BIOS; identifying a processor environment installed on an information handling system from a plurality of processor environments, the processor environment comprising a processor architecture; and, performing a dynamic workload management operation, the dynamic workload management operation managing a workload executing on the information handling system, the dynamic workload management operation being processor environment agnostic.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of Authenticated Basic Input/Output System (BIOS) Interface services implemented within a cloud computing environment;

FIG. 6 is a simplified block diagram of a dynamic workload management operation;

FIG. 7 is a block diagram showing a dynamic workload management architecture.

FIG. 8 is a block diagram of a processor configuration used in a dynamic workload management architecture;

FIG. 9 shows example entries in an extended ACPI table; and,

FIG. 10 shows example entries in a workload identification table.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure reflect an appreciation that as the demands on artificial intelligence (AI) systems continue to grow, the need for efficient and powerful processing capabilities becomes increasingly important. Various aspects of the present disclosure reflect an appreciation that known information handling system designs do not incorporate an efficient processor environment agnostic AI Offload engine. Various aspects of the present disclosure reflect an appreciation that it would be desirable to provide a processor environment agnostic AI offload engine which is based on workload context. Various aspects of the present disclosure include an appreciation that such a processor environment agnostic AI offload engine could increase system efficiency in terms of power and performance.

Various aspects of the present disclosure reflect an appreciation that known process environment specific hardware cache designs are not optimized for AI workloads. Various aspects of the present disclosure reflect an appreciation with known process environment specific hardware cache designs when an AI workload is offloaded to a graphics processing unit (GPU) or neural processing unit (NPU), the cache address lines associated with the AI workload can become dispersed. Various aspects of the present disclosure reflect an appreciation dispersing the cache lines associated with the AI workload can slow execution of the AI workload.

Various aspects of the present disclosure reflect an appreciation that it would be desirable for heterogeneous computing platforms to integrate GPUs and NPUs as intelligent workload managers. Various aspects of the present disclosure reflect an appreciation that while known GPU/NPUs designs are primarily used for AI acceleration, the GPU/NPUs could take on a more strategic role. Various aspects of the present disclosure reflect an appreciation that known GPU/NPU designs are not optimized in pre-boot environments where systems allocate resources and manage foundational tasks before transitioning to an operating system runtime phase of operation. Various aspects of the present disclosure reflect an appreciation that it would be desirable to optimize cache systems within the pre-boot environment. Various aspects of the present disclosure include an appreciation that it would be desirable to leverage GPU/NPUs in pre-boot environments to enhance performance, delivering a smoother experience to the user.

Various aspects of the present disclosure reflect an appreciation that multiple device attributes can impact performance and not optimizing these device attributes can result in an inefficient initialization process. Various aspects of the present disclosure reflect an appreciation that devices often have various attributes contributing to performance levels (e.g., low, mid, high, or extreme) where the various attributes should be synchronized. Various aspects of the present disclosure reflect an appreciation that devices often have attributes like memory frequency, network frequency, and CPU utilization which should align for optimal performance. Various aspects of the present disclosure reflect an appreciation that during boot-up, devices are initialized with default attributes, which can lead to high or low power consumption and lack of synchronization with a particular workload and platform ecosystem.

Various aspects of the present disclosure reflect an appreciation that known system designs often present dynamic workload challenges and a lack of intelligent learning mechanisms. Various aspects of the present disclosure reflect an appreciation that AI workloads are often heterogeneous and dynamic. Various aspects of the present disclosure reflect an appreciation that it would be desirable to adaptively tune performance attributes for the best performance when executing particular AI workloads. Various aspects of the present disclosure reflect an appreciation that known system designs often rely on static initialization and do not adjust performance attributes dynamically based on workload context. Various aspects of the present disclosure reflect an appreciation that no intelligent algorithms are known which learn device performance under specific workloads, capture and utilize historical data for tasks involving CPU, GPU, network, storage, etc.

Various aspects of the present disclosure reflect an appreciation that known system designs often require reboot dependency and lack real-time firmware tuning. Various aspects of the present disclosure reflect an appreciation that the inability to modify device attributes or reinitialize firmware in real-time often results in reliance on system reboots, leading to wasted time and missed opportunities for dynamic workload optimization. Additionally, static firmware settings often prevent devices from adapting to changing workloads, limiting the effectiveness of operating system algorithms and hindering overall system performance.

Various aspects of the present disclosure reflect an appreciation that it would be desirable to provide a smart cache architecture which enables smart cached objects. Various aspects of the present disclosure reflect an appreciation that such a cache architecture can significantly enhance the execution of AI workloads. Various aspects of the present disclosure reflect an appreciation that such a cache architecture facilitates dynamically offloading tasks to a GPU, an NPU, or a combination thereof. Various aspects of the present disclosure reflect an appreciation that such a cache architecture can improve both power efficiency and overall system performance.

Various aspects of the present disclosure include an appreciation that smart cached objects enable faster access to AI workloads by the GPU and NPU, allowing the GPU and NPU to process data more quickly and effectively. Various aspects of the present disclosure include an appreciation that it is desirable to learn a context of a workload, which aids an AI scheduler in making more efficient operational decisions. Various aspects of the present disclosure include an appreciation that it is desirable to intelligently manage the cache, which can reduce latency and ensure that important tasks are prioritized, leading to smoother and more responsive AI application executions.

A system and method are disclosed for performing a dynamic workload management operation. In certain embodiments the dynamic workload management operation provides a smart cache architecture which enables smart cached objects.

In certain embodiments, the dynamic workload management operation utilizes NPUs, GPUs, or a combination thereof, as AI Accelerator. In certain embodiments, the dynamic workload management operation performs learning based dynamic workload allocation among pre-determined efficiency cores and performance cores. In certain embodiments, the dynamic workload management operation uses an NPU learning acceleration protocol.

In certain embodiments, the dynamic workload management operation provides processor environment independent smart cached objects. In certain embodiments, the processor environment independent smart cached objects enable GPU/NPU with faster access to most frequently used AI workload context created over device specific memory objects.

In certain embodiments, the dynamic workload management operation learns platform context and AI workload execution history and dynamically tunes a platform device configuration set. In certain embodiments, when tuning the platform device configuration set, the dynamic workload management operation uses enhanced advanced configuration and power interface (ACPI) Tables. In certain embodiments, the enhanced ACPI Tables enable power efficient operations.

In certain embodiments, the dynamic workload management operation uses a processor accelerator acceleration protocol. In certain embodiments, the processor accelerator acceleration protocol allows AI workloads to be seamlessly offloaded from the CPU without any interruption. In certain embodiments, the processor accelerator acceleration protocol allows AI workloads to be seamlessly offloaded from the CPU to a GPU, an NPU, or a combination thereof. In certain embodiments, the smart cached objects ensure faster access to AI workloads. In certain embodiments, the AI workloads are cloud based. In certain embodiments, the smart cached objects allow the dynamic workload management operation to increase system response time and overall system performance. In certain embodiments, the context aware dynamic tuning facilitates power efficient AI workload execution.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

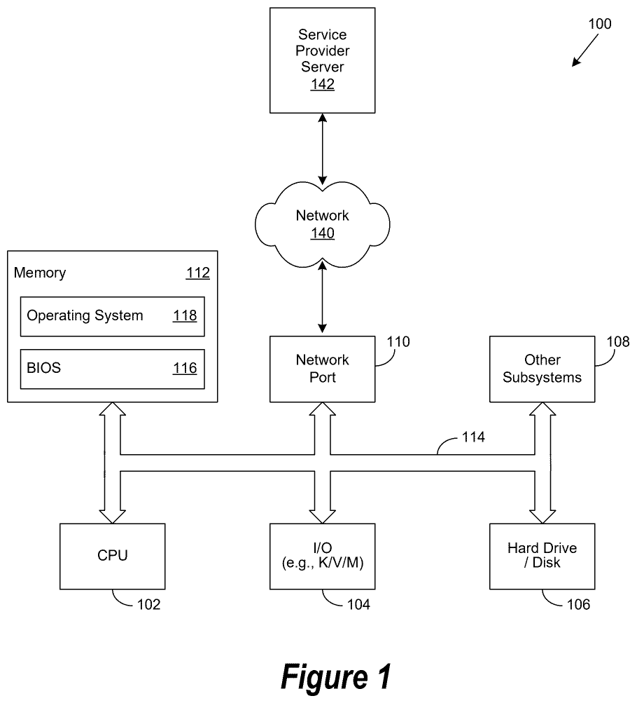

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an . efi file, rather than on its associated firmware. In typical implementations, the . efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a dynamic workload management operation.

A dynamic workload management operation, as used herein, broadly refers to any function, task, procedure, or process performed, directly or indirectly, within a multi-processor operating environment, or an architecture-specific distributed firmware management platform (ASDFMP), both of which are described in greater detail herein, to generate, instantiate, secure, distribute, provision, authenticate, implement, modify, update, replace, monitor, or manage, or a combination thereof, a workload executing within the architecture-specific distributed firmware management platform. In various embodiments, the dynamic workload management operation is processor environment agnostic. In certain embodiments, the firmware management operation may be performed during operation of an IHS 100. In various embodiments, performance of the firmware management operation may result in the realization of improved operation of an IHS 100.

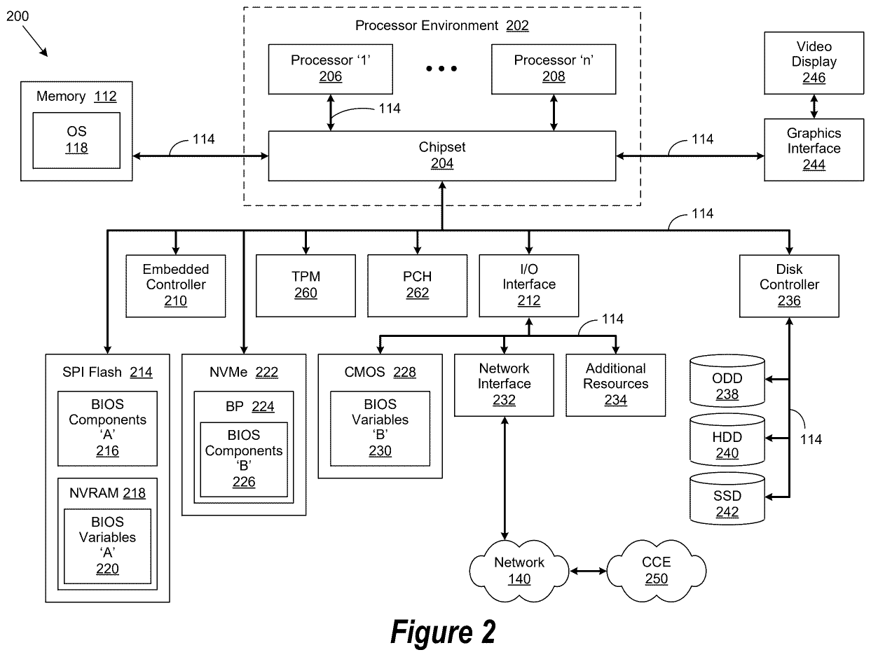

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment. In various embodiments, one or more processors ‘1’ 206 through ‘n’ 208 implemented within a PE 202 may be implemented to include one or more central processing units, graphics processing units, neural processing units, application processing units, or combination thereof. In various embodiments, one or more processors ‘1’ 206 through ‘n’ 208 implemented within a PE 202 may be implemented to include efficiency cores, performance cores, or a combination thereof.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

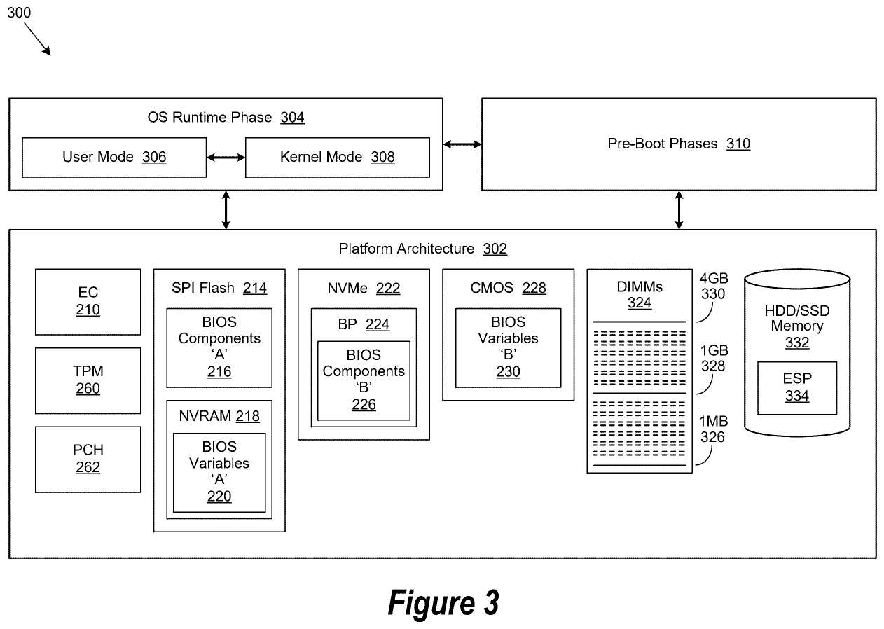

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

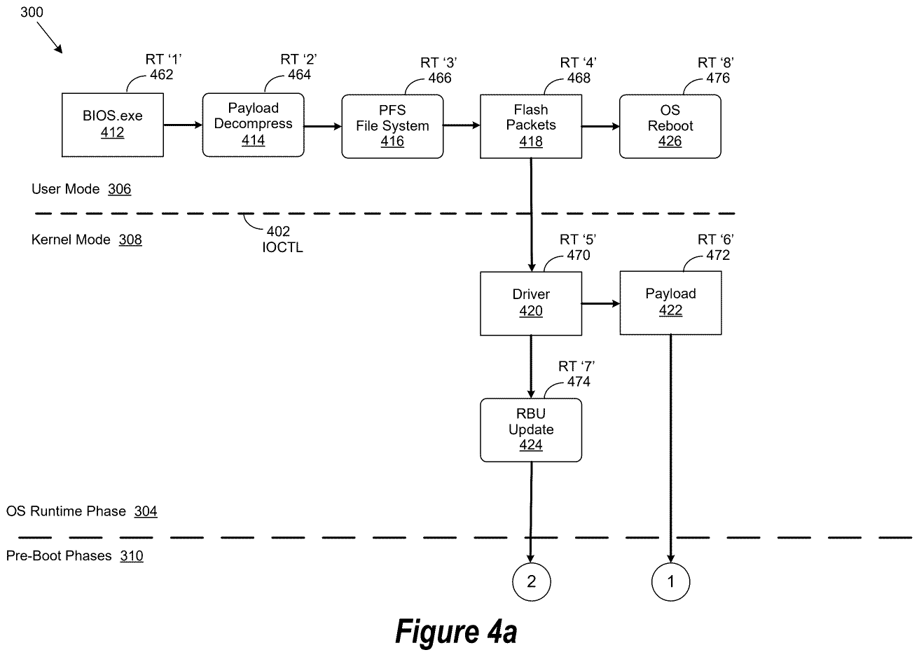

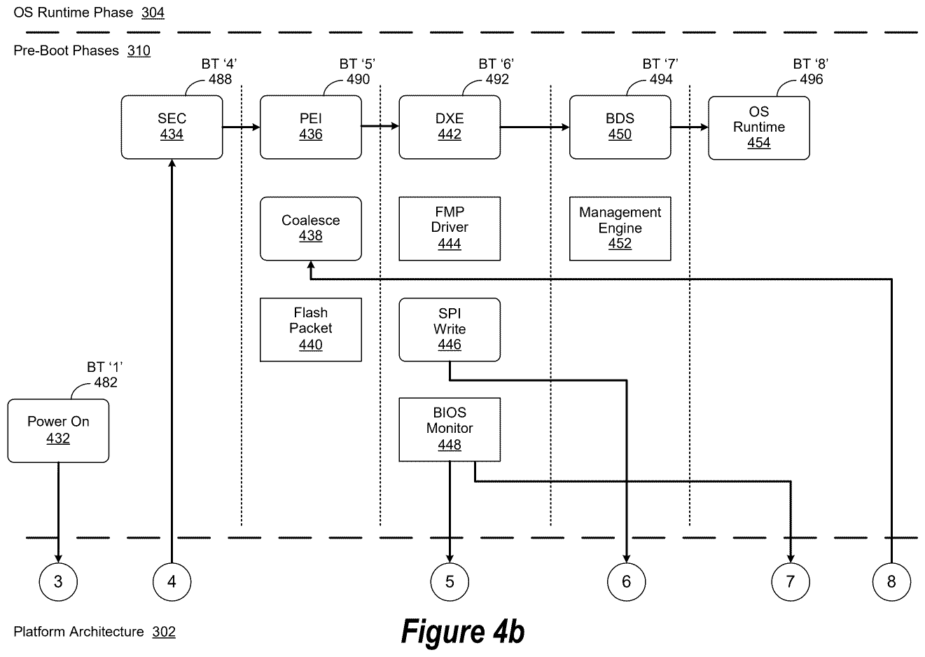

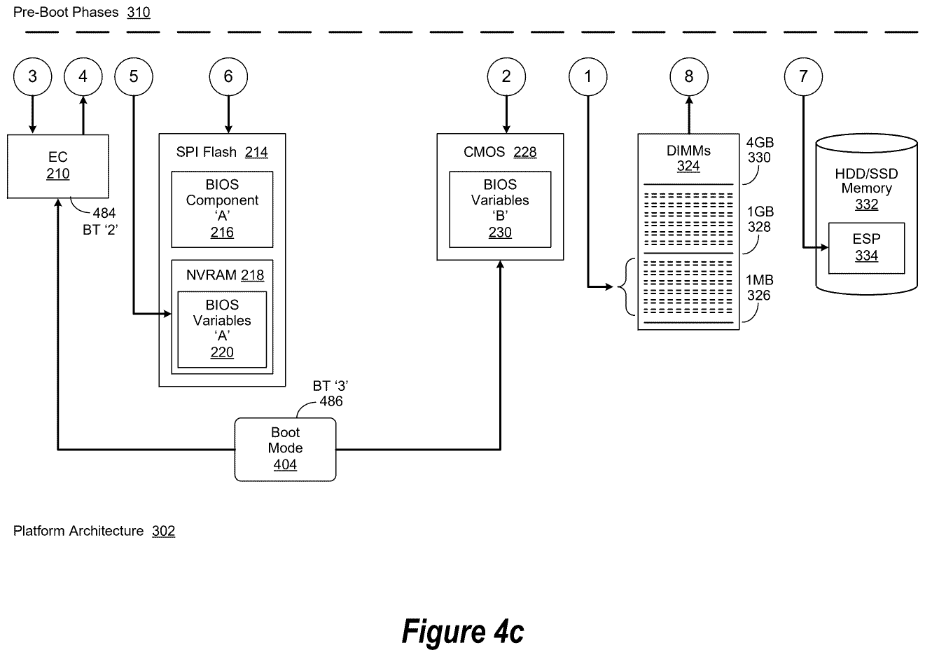

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS. exe 412 file in runtime (RT) step ‘1’ 462. In various embodiments, the BIOS. exe 412 file may be implemented as the combination of a flash memory utility and a payload of firmware components, described in greater detail herein. Then, in RT step ‘2’ 464 the BIOS. exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one or more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

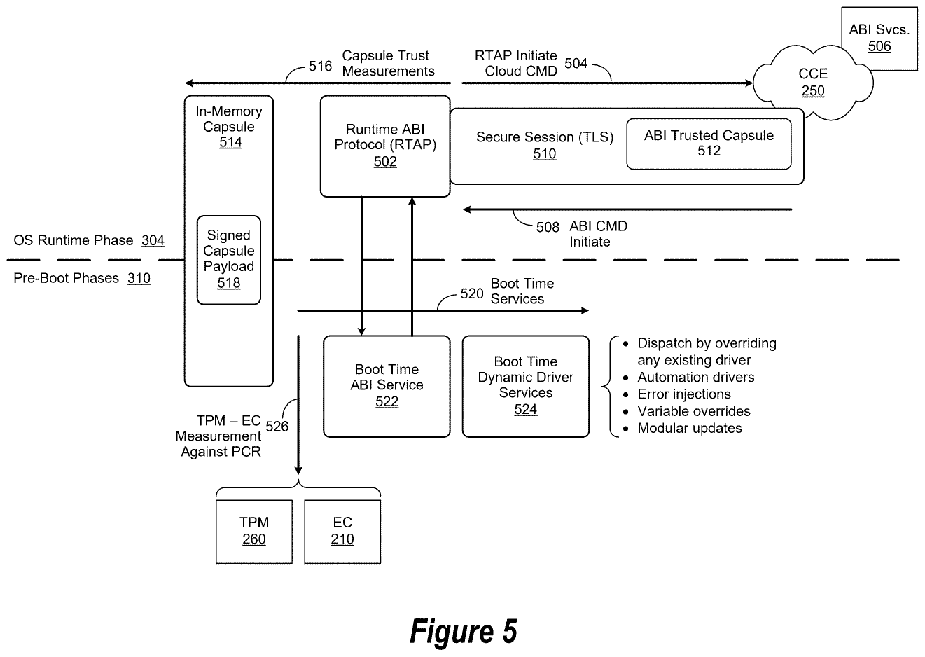

FIG. 5 is a simplified block diagram of Authenticated Basic Input/Output System (BIOS) Interface (ABI) services implemented within a cloud computing environment in accordance with an embodiment of the invention. Various embodiments of the invention reflect an appreciation that running learning models on client devices has become more common as artificial intelligence (AI) evolves. Likewise, various embodiments of the invention reflect an appreciation that large learning models (LLMs) have traditionally been deployed on powerful server infrastructures due to their extensive computational requirements.

However, various embodiments of the invention reflect an appreciation that deploying LLMs on client devices may provide certain advantages, such as a more personalized user experience, faster remediation, more immediate support, more robust data privacy, and so forth. Accordingly, an AI-capable intelligent Basic Input/Output System (BIOS), incorporating advanced algorithms and machine learning capabilities to enhance its functionality, may be implemented in various embodiments. In various embodiments, this intelligent BIOS may be implemented to autonomously detect, diagnose, and remediate issues without human intervention and provide adaptive performance and predictive maintenance.

Likewise, an eXtensible Host Controller Interface (XHCI), described in greater detail herein, may be implemented in various embodiments to improve system speed, power efficiency, and virtualization. Various embodiments of the invention likewise reflect an appreciation that typical storage capacities of portable devices have been increasing over time, with a concomitant need for high performance interfaces so they can be loaded in a reasonable amount of time. Accordingly, the implementation of an xHCI in various embodiments may reduce, or even eliminate, host memory-based transaction schedules, while its support for advanced power management features may likewise provide more power efficient platforms without sacrificing performance.

In various embodiments, the enablement of certain xHCI virtualization features may likewise allow direct assignment of individual Universal Serial Bus (USB) devices to any virtual machine (VM), irrespective of their location within a particular bus topology, to minimize run-time inter-VM communications, and provide support for native USB device sharing, or a combination thereof. Likewise, the implementation of an AI-capable intelligent BIOS in various embodiments may enable support of heterogeneous System on Chip (SoC) vendors, such as Intel®, AMD®, Qualcomm®, NVIDIA®, and so forth. The implementation of an AI-capable intelligent BIOS in various embodiments may likewise enable seamless interdependent updates services for a system's operating system (OS) and firmware. Likewise, the implementation of an intelligent cache in various embodiments may allow one or more Graphics Processing Units (GPUs), Neural Processing Units (NPUs), Accelerated Processing Units (APUs), or a combination thereof, to be leveraged to process AI workloads while supporting host embedded controller (EC) 210 side-band interrupts.

Referring now to FIG. 5, a runtime ABI protocol (RTAP) 502 may be implemented in various embodiments during a system's OS runtime phase 304. In various embodiments, the RTAP 502 may be implemented to initiate an RTAP cloud command (CMD) 504 to access certain ABI services 506, which in certain embodiments may be implemented within a cloud computing environment (CCE) 250, described in greater detail herein. In various embodiments, initiation of the RTAP cloud CMD 504 may result in certain ABI services 506 initiating an ABI CMD 508 in response.

In various embodiments, initiation of the ABI CMD 508 may result in establishing a secure session 510 between the RTAP 502 and the ABI services 506. In various embodiments, the Transport Layer Security (TLS) protocol, familiar to skilled practitioners of the art, may be used to establish the secure session 510 between the RTAP 502 and the ABI services 506. In various embodiments, the secure session 510 may be implemented to allow the ABI services 506 to provide an ABI trusted capsule 512 to the RTAP 502.

In various embodiments, the RTAP 502 may be implemented to load the ABI trusted capsule 512 into system memory as an in-memory capsule 514. In various embodiments, the RTAP 502 may likewise be implemented to perform certain capsule trust measurements 516. Likewise, the RTAP 502 may be implemented in various embodiments to generate a digitally-signed capsule payload 518.

In various embodiments, the RTAP 502 may be implemented to use the contents of the digitally-signed capsule payload 518 to create certain boot time services 520 for use during various pre-boot phases 310. In various embodiments, the boot time services 520 may include a boot time ABI service 522 and one or more boot time dynamic driver services 524. In various embodiments, the boot time ABI service 522 may be implemented to perform certain Trusted Platform Module (TPM) 260 and Embedded Controller (EC) 210 comparisons and measurements 526 against the system's Platform Configuration Register (PCR). In various embodiments the one or more boot time dynamic driver services 524 may be implemented to provide various functionalities, such as performing a dispatch by overriding any existing driver, initiating one or more automation drivers, initiating one or more error injections, performing one or more variable overrides, performing one or more modular updates, and so forth.

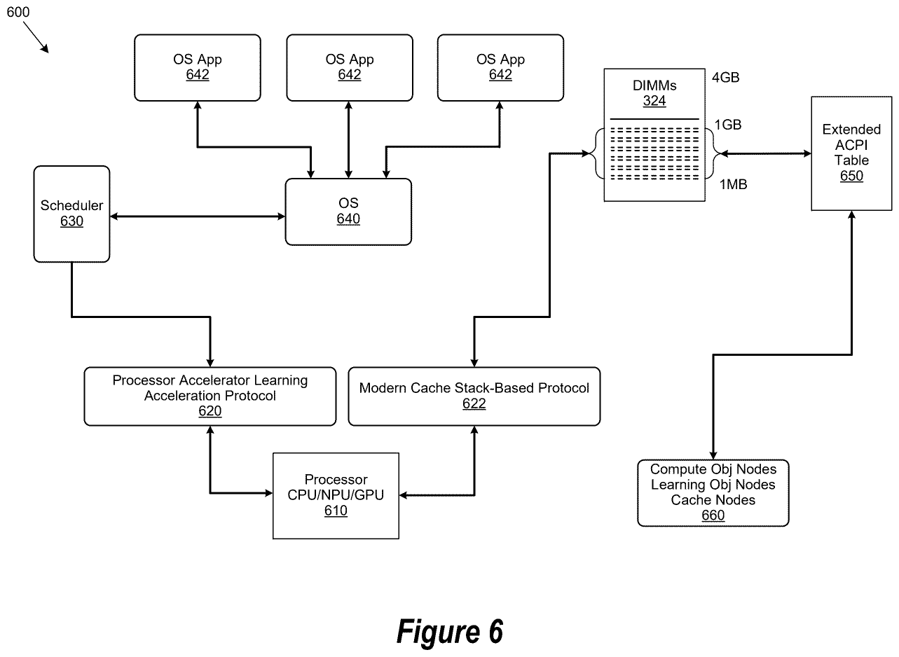

FIG. 6 is a simplified block diagram of a dynamic workload management operation 600. In certain embodiments, the dynamic workload management operation 600 executes within a multi-processor operating environment such as multi-processor operating environment 200.

In certain embodiments, the dynamic workload management operation 600 provides a smart cache architecture which enables smart cached objects.

In certain embodiments, the dynamic workload management operation 600 utilizes a processor environment 610 which includes CPUs, NPUs, GPUs, or a combination thereof. In certain embodiments, the processor environment 610 corresponds to processor environment 202. In certain embodiments, the dynamic workload management operation 600 utilizes NPUs, GPUs, or a combination thereof, as AI accelerators. In certain embodiments, the dynamic workload management operation 600 performs learning based dynamic workload allocation among pre-determined efficiency cores and performance cores contained within the processor environment 610. In certain embodiments, the dynamic workload management operation 600 uses a processor accelerator learning acceleration protocol 620, a modern cache stack-based protocol 622, or a combination thereof. In certain embodiments, the learning is context aware. As used herein, context awareness broadly refers to a capability of the dynamic workload management operation 600 to sense and react based upon information associated with one or more operational conditions associated with an information handling system environment such as a multi-processor operating environment 200. In certain embodiments, the operational conditions are related to execution of a workload such as an AI workload within the information handling system environment.

As used herein, a processor accelerator learning acceleration protocol 620 broadly refers to a set of rules for formatting and processing data associated with performance of a processor accelerator learning acceleration operation, described in greater detail herein. As used herein, a processor accelerator learning acceleration operation broadly refers to a firmware management operation, described in greater detail herein, performed directly, or indirectly, within a multi-processor operating environment 200 to manage offloading of AI workloads from a CPU to a processor accelerator. In certain embodiments, the offloading is context aware. In certain embodiments, the processor accelerator includes a GPU, an NPU, or a combination thereof.

In certain embodiments, the processor accelerator acceleration protocol 620 allows AI workloads to be seamlessly offloaded from the CPU without any interruption. In certain embodiments, the processor accelerator acceleration protocol allows AI workloads to be seamlessly offloaded from the CPU to a GPU, an NPU, or a combination thereof. In certain embodiments, the processor accelerator acceleration protocol 620 communicates with a scheduler 630 when performing the processor accelerator learning acceleration operation. In certain embodiments, the scheduler 630 interacts with an operating system 640 via which a plurality of operating system application 642 are executing. In certain embodiments, one or more of the operating system applications 642 includes an associated AI workload. In certain embodiments, the processor accelerator acceleration protocol 620 allows AI workloads executing on the operating system applications to be seamlessly offloaded from the CPU to a processor accelerator without any interruption.

As used herein, a modern cache stack-based protocol 622 broadly refers to a set of rules for formatting and processing data associated with performance of a modern cache stack-based operation, described in greater detail herein. As used herein, a modern cache stack-based operation broadly refers to broadly refers to a firmware management operation, described in greater detail herein, performed directly, or indirectly, within a multi-processor operating environment 200 to store, retrieve, aggregate, disaggregate, add, delete, modify, revise, update, replace, or restore objects within a modern cache. In certain embodiments, the objects are associated with an AI workload. In certain embodiments, the modern cache is instantiated within a low region of memory, as used herein. In certain embodiments, the low region of memory is maintained within one or more DIMMs 324.

In certain embodiments, the modern cache stack-based operation provides processor environment independent smart cached objects. As used herein, a processor environment independent smart cached object broadly refers to an intelligently managed piece of data stored in a cache, where the piece of data executes within one of a plurality of processor environments. The modern cache stack-based operation intelligently manages the data by making a determination of which data to cache, when to update the data within the cache, and when to remove the data from the cache, where the determination is based on factors such as the type of processor environment on which the data executes, usage patterns, data freshness, and specific conditions, and the determination aims to optimize performance of the cache by prioritizing frequently accessed and relevant information while minimizing unnecessary cache storage.

In certain embodiments, the processor environment independent smart cached objects enable GPU/NPU with faster access to most frequently used AI workload context created over device specific memory objects. In certain embodiments, the smart cached objects ensure faster access to AI workloads. In certain embodiments, the AI workloads are cloud based. In certain embodiments, the smart cached objects allow the dynamic workload management operation 600 to increase system response time and overall system performance. In certain embodiments, the context aware dynamic tuning facilitates power efficient AI workload execution. In certain embodiments, when managing the smart cached objects, the dynamic workload management operation uses extended ACPI Tables 650. In certain embodiments, the extended ACPI tables 650 conform to an ACPI standard. In certain embodiments, the ACPI tables 650 are used by the operating system 640 to discover and configure hardware components. In certain embodiments, the operating system 640 discovers and configures the hardware components during an operating system runtime phase of operation.

In certain embodiments, the dynamic workload management operation 600 learns platform context and AI workload execution history and dynamically tunes a platform device configuration set 660. In certain embodiments, when tuning the platform device configuration set 660, the dynamic workload management operation uses extended ACPI Tables 650. In certain embodiments, the extended ACPI Tables 650 enable power efficient operations.

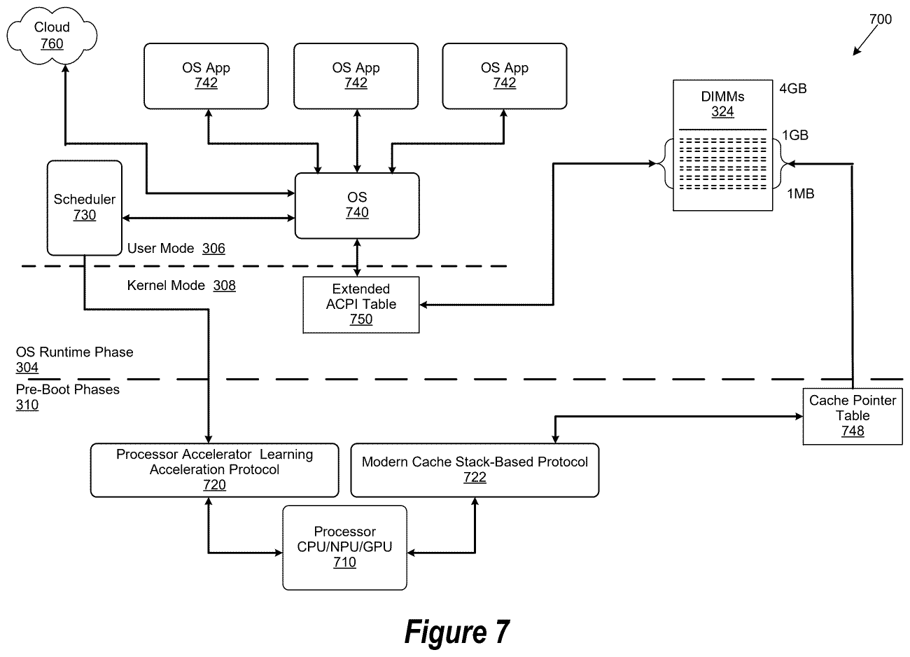

FIG. 7 is a block diagram showing a dynamic workload management architecture 700. In certain embodiments, the dynamic workload management architecture 700 is included within a multi-processor operating environment such as multi-processor operating environment 200. In certain embodiments, the dynamic workload management architecture 700 executes a dynamic workload management operation. In certain embodiments, the dynamic workload management architecture 700 provides a smart cache architecture which enables smart cached objects.

In certain embodiments, the dynamic workload management operation 700 utilizes a processor environment 710 which includes CPUs, NPUs, GPUs, or a combination thereof. In certain embodiments, the processor environment 710 corresponds to processor environment 202. In certain embodiments, the dynamic workload management operation 700 utilizes NPUs, GPUs, or a combination thereof, as AI accelerators. In certain embodiments, the dynamic workload management operation 700 performs learning based dynamic workload allocation among pre-determined efficiency cores and performance cores contained within the processor environment 710. In certain embodiments, the dynamic workload management operation 700 uses a processor accelerator learning acceleration protocol 720, a modern cache stack-based protocol 722, or a combination thereof. In certain embodiments, the processor accelerator learning acceleration protocol 720, the modern cache stack-based protocol 722, or a combination thereof, execute during a pro-boot phase 310 of operation.

In certain embodiments, the processor accelerator learning acceleration protocol 720 performs a processor accelerator learning acceleration operation. In certain embodiments, the processor accelerator acceleration protocol 720 allows AI workloads to be seamlessly offloaded from the CPU without any interruption. In certain embodiments, the processor accelerator acceleration protocol allows AI workloads to be seamlessly offloaded from the CPU to a GPU, an NPU, or a combination thereof. In certain embodiments, the processor accelerator acceleration protocol 720 communicates with a scheduler 730 when performing the processor accelerator learning acceleration operation. In certain embodiments, the scheduler 730 interacts with an operating system 740 via which a plurality of operating system application 742 are executing. In certain embodiments, one or more of the operating system applications 742 includes an associated AI workload. In certain embodiments, the processor accelerator acceleration protocol 720 allows AI workloads executing on the operating system applications to be seamlessly offloaded from the CPU to a processor accelerator without any interruption.

In certain embodiments, the modern cache stack-based protocol 722 performs a modern cache stack-based operation. In certain embodiments, the modern cache stack-based operation provides processor environment independent smart cached objects. The modern cache stack-based operation intelligently manages the data by making a determination of which data to cache, when to update the data within the cache, and when to remove the data from the cache, where the determination is based on factors such as usage patterns, data freshness, and specific conditions, and the determination aims to optimize performance of the cache by prioritizing frequently accessed and relevant information while minimizing unnecessary cache storage. In certain embodiments, the modern cache stack-based protocol 722 manages a cache pointer table 748.

In certain embodiments, the processor environment independent smart cached objects enable GPU/NPU with faster access to most frequently used AI workload context created over device specific memory objects. In certain embodiments, the smart cached objects ensure faster access to AI workloads. In certain embodiments, the AI workloads are cloud based. In certain embodiments, the smart cached objects allow the dynamic workload management operation 700 to increase system response time and overall system performance. In certain embodiments, the context aware dynamic tuning facilitates power efficient AI workload execution. In certain embodiments, when managing the smart cached objects, the dynamic workload management operation uses extended ACPI Tables 750. In certain embodiments, the extended ACPI tables 750 conform to an ACPI standard. In certain embodiments, the ACPI tables 750 are used by the operating system 640 to discover and configure hardware components. In certain embodiments, the operating system 740 discovers and configures the hardware components during an operating system runtime phase 304 of operation. In certain embodiments, the operating system 740 discovers and configures the hardware components during a kernel mode 308 of an operating system runtime phase 304 of operation.

In certain embodiments, the dynamic workload management operation 700 learns platform context and AI workload execution history and dynamically tunes a platform device configuration set 760. In certain embodiments, when tuning the platform device configuration set 760, the dynamic workload management operation uses extended ACPI Tables 750. In certain embodiments, the extended ACPI tables 750 are managed during a kernel mode 308 of an operating system runtime phase 304 of operation. In certain embodiments, the extended ACPI Tables 750 enable power efficient operations. In certain embodiments, the In certain embodiments, the processor accelerator learning acceleration protocol 720, the modern cache stack-based protocol 722, or a combination thereof, interact with the extended ACPI Tables 750.

In certain embodiments, the dynamic workload management operation provides a pre-boot solution which overcomes the lack of intelligent workload balancing and inefficient task execution in the pre-boot environment. In certain embodiments, the dynamic workload management operation enables the full utilization of heterogeneous cores such as E-cores (Efficiency cores) and P-cores (Performance cores). In certain embodiments, the dynamic workload management operation leverages NPU/GPU operation by using the processor accelerator learning acceleration protocol 720. In certain embodiments, the processor accelerator learning acceleration protocol 720 enables the NPU, the GPU, or a combination thereof, to act as an AI accelerator during the pre-boot phase.

During the initial boot-up, the operating system scheduler 730 performs a minimal role, mapping essential operating system applications 742 to CPU cores. Once this initial allocation is complete, the accelerator (e.g., the NPU, the GPU, or a combination thereof) leverages AI intelligence to dynamically reallocate tasks based on workload thresholds and system requirements. This reallocation allows tasks to shift between P-cores and E-cores depending on performance and efficiency needs. Additionally, integrating heterogeneous processing resources such as CPU, NPU, and GPU during the pre-boot phase eliminates dependence on the post-boot operating system environment. This approach not only optimizes task execution during boot-up but also ensures a balance between power efficiency and performance, enhancing overall system efficiency and scalability.

After leveraging the accelerator for workload management, which can dynamically adapt based on workload stress, the system utilizes a modern cache stack-based protocol 722 to further enhance efficiency. In certain embodiments, the modern cache stack-based protocol 722 collects workload history and stores/stack this information in a cache maintained within memory using the structured modern cache pointer table 748. By referencing this pointer table, the workload data is systematically stored in the modern cache, ensuring rapid access and improved processing efficiency in future operations. This approach not only streamlines data handling but also optimizes system performance by maintaining a comprehensive and accessible workload history.

Parameters associated with this information are collectively stored into the DIMM Cache that 1 MB to 1 GB cache memory, all these parameter attributes are maintained and managed via the extended ACPI table 750. The table parameters are maintained and managed by the extended ACPI table 750 to maintain/utilize the data during an operating system runtime phase 304 of operation.

In certain embodiments, the dynamic workload management operation efficiently manages processor environments, peripheral components, or a combination thereof, provided by different venders. In certain embodiments, the processor environments, peripheral components, or a combination thereof, have different associated configuration attributes. In certain embodiments, the dynamic workload management operation efficiently manages the different associated configuration attributes.

For example, many vendor components have multiple attributes, with each attribute contributing to performance of a particular device that can be a lower performance, mid-level performance, hi-level performance and sometimes extreme level performance. Additionally, venders also add additional attributes. In some cases, four or five attributes can be synchronized. For example, if memory is at high frequency, the memory should also be in a frequency to match the network frequency and the CPU also should match. In this way, the dynamic workload management operation applies power and thermal based analysis to create a virtual thermal zone (which is maintained within the ACPI table 750) or a power zone (which is maintained within the ACPI table 750) to provide optimal performance for the system. By using the dynamic workload management operation, there is no need to resume/restart the system during runtime. The dynamic workload management architecture 700 uses the attributes which were previously stored in the cache. By doing so, the information handling system can be initialized with attributes during the boot time/runtime.

In certain embodiments, once the system boots into the operating system with

the required hardware information, the collected attribute data is automatically synchronized and uploaded to the cloud 760. By updating this information to a remote storage location, when the same hardware, such as a NIC card, is installed on another system, this information can be used for the other system. By accessing the cloud-stored hardware configuration attributes, the new system can automatically retrieve and apply the necessary settings without requiring a reboot. This process streamlines hardware installation, eliminates unnecessary downtime, and ensures seamless integration of components with minimal user intervention, especially for hardware with extensive attribute configurations.

The modern cache advantageously enhances system performance by utilizing previously stored workload information within the system's cache, enabling faster and more efficient processing. Additionally, leveraging the NPU, the GPU, or a combination thereof, for AI-driven workload balancing by dynamically allocating tasks to E-cores and P-cores based on power and thermal configurations, ensures optimal performance and efficiency. Additionally, by storing hardware configuration attributes in the ACPI table 750 and synchronizing the configuration attributes to the cloud 760 enables seamless retrieval of important data during the installation of hardware components, such as NIC cards, eliminating the need for additional system reboots and ensuring efficient integration.

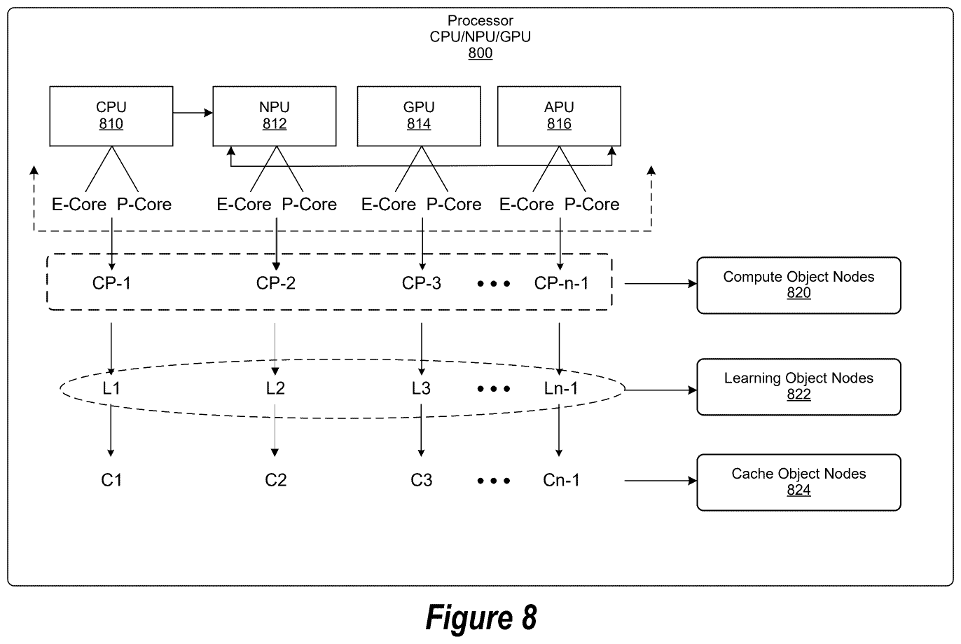

FIG. 8 is a block diagram of a processor environment configuration 800 used in a dynamic workload management architecture. In certain embodiments, the processor environment configuration 800 corresponds to processor environment 202.

In certain embodiments, the processor environment configuration 800 includes a plurality of processors. In certain embodiments, the plurality of processors includes one or more CPUs 810, one or more NPUs 812, one or more GPUs 814, one or more APUs 816, or a combination thereof. In certain embodiments, some or all of the one or more CPUs 810, the one or more NPUs 812, the one or more GPUs 814, the one or more APUs 816, or a combination thereof, include a plurality of cores. In certain embodiments, the plurality of cores includes E-cores, P-cores, or a combination thereof. In certain embodiments, some or all of the one or more CPUs 810, the one or more NPUs 812, the one or more GPUs 814, the one or more APUs 816, or a combination thereof, have associated compute object nodes 820 (CP-1, CP-2, CP-3, CP-n-1), associated learning object nodes 822 (L1, L2, L3, Ln-1), associated cache object nodes 824 (C1, C2, C3, Cn-1), or a combination thereof.

In certain embodiments, the compute object nodes 820 provide a collective of hardware attribute information associated with the processors. In certain embodiments, the collective of hardware attribute information is used to manage attributes of the processors without needing a reboot. In certain embodiments, the learning object nodes 822 learn information associated with executing workloads on the processors. In certain embodiments, the workloads include AI workloads. In certain embodiments, the learned information is used to update cache object nodes 824.

In certain embodiments, the dynamic workload management operation leverages the capabilities of the CPUs 810, NPUs 812, GPUs 814, APUs 816, or a combination thereof. In certain embodiments, the dynamic workload management operation dynamically balances a workload across E-cores and P-cores to optimize performance and efficiency. Simultaneously, the system retains a record of previous workload attributes to enhance future operations. In certain embodiments, information collected from various components is stored within respective compute object nodes 820 (CpN). In certain embodiments, the compute object nodes 820 gather configuration attributes from multiple devices and hardware components, including those from different vendors. The collected data is then processed and intelligently learned by an associated learning object node 822 (LN), which organizes and stores the learned data into an associated cache node 824. The cache node 824 integrates and manages diverse cache types such as CPU Cache, GPU Cache, NVRAM Cache, NVMe Cache, OPRom Cache, and Storage Cache. This holistic approach ensures seamless integration of heterogeneous components while optimizing resource utilization and system intelligence.

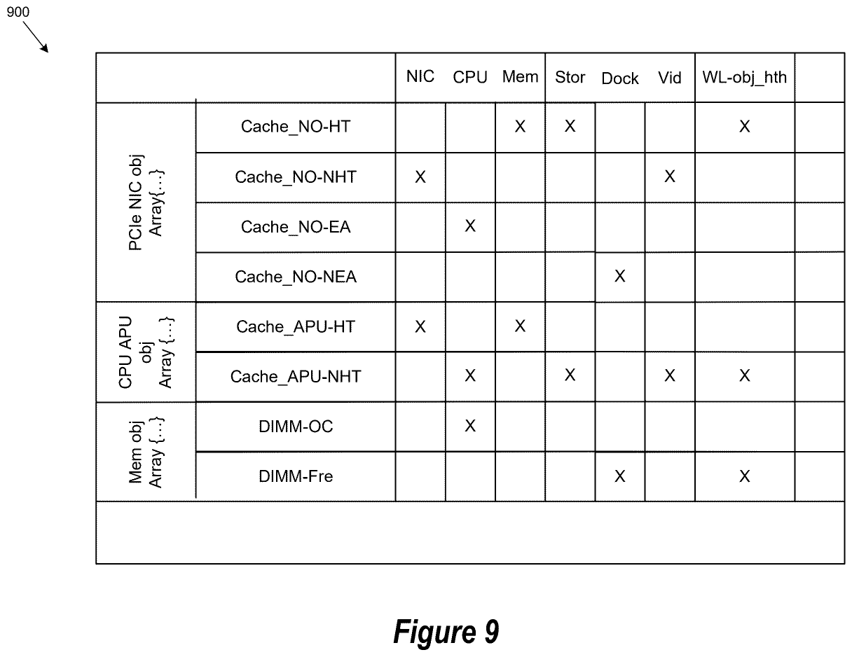

FIG. 9 shows example entries in an extended ACPI table 900. In certain embodiments, the extended ACPI table 800 corresponds to extended ACPI table 650, ACPI table 750, or a combination thereof. In certain embodiments, the ACPI table 900 is used by an operating system to discover and configure hardware components. In certain embodiments, the operating system discovers and configures the hardware components during an operating system runtime phase of operation. In certain embodiments, the operating system discovers and configures the hardware components during a kernel mode of an operating system runtime phase of operation. In certain embodiments, the hardware components include memory of the information handling system. In certain embodiments, the configuring the hardware components includes managing a cache within the memory.

In certain embodiments, the ACPI table 900 includes information associated with a plurality of hardware components. In certain embodiments, the plurality of hardware components include network components, processor components, memory components, storage components, dock components, video components In certain embodiments, the ACPI table 900 includes information associated with a plurality of workloads.

In certain embodiments, the ACPI table 900 includes a plurality of component attributes. In certain embodiments, the plurality of component attributes include network device attributes, processor attributes, memory attributes, or a combination thereof. In certain embodiments, memory attributes include cache attributes. In certain embodiments, the plurality of component attributes includes NIC object heterogeneous (NO-HT). NIC object, non-heterogeneous (NO-NHT), NIC object enhanced array (NO-EA), NIC object non enhanced array (NO-NEA), Cache object heterogeneous (Cache_APU-HT). Cache object, non-heterogeneous (Cache_APU-NHT), first form memory object (DIMM-OC), second form memory object (DIMM-Fre), or a combination thereof.

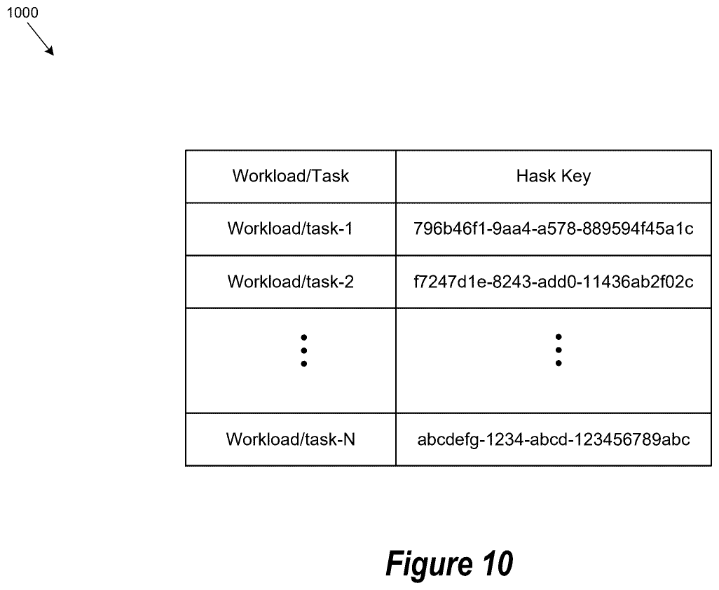

FIG. 10 shows example entries in a workload identification table 1000. In certain embodiments, the workload identification table 1000 includes workload identification information (workload/task—1, workload/task—2, workload/task-n). In certain embodiments, each identified workload includes an associated identifier. In certain embodiments, the associated identifier includes a respective hash key.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a dynamic workload management operation, the dynamic workload management operation managing a workload executing on the information handling system, the dynamic workload management operation being processor environment agnostic.

2. The method of claim 1, wherein:
the dynamic workload management operation includes a processor accelerator learning acceleration operation, the processor accelerator learning acceleration operation managing offloading of artificial intelligence workloads from a processor of the processor environment to a processor accelerator.

3. The method of claim 2, wherein:
the processor accelerator learning acceleration operation is context aware.

4. The method of claim 1, wherein:
the dynamic workload management operation includes a cache stack-based operation, the cache stack-based operation managing objects within a cache of the information handling system.

5. The method of claim 4, wherein:
the objects are associated with an artificial intelligence workload.

6. The method of claim 4, wherein:
the objects include processor environment independent smart cached objects.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture; and,
performing a dynamic workload management operation, the dynamic workload management operation managing a workload executing on the information handling system, the dynamic workload management operation being processor environment agnostic.

8. The system of claim 7, wherein:
the dynamic workload management operation includes a processor accelerator learning acceleration operation, the processor accelerator learning acceleration operation managing offloading of artificial intelligence workloads from a processor of the processor environment to a processor accelerator.

9. The system of claim 8, wherein:
the processor accelerator learning acceleration operation is context aware.

10. The system of claim 7, wherein:
the dynamic workload management operation includes a cache stack-based operation, the cache stack-based operation managing objects within a cache of the information handling system.

11. The system of claim 10, wherein:
the objects are associated with an artificial intelligence workload.

12. The system of claim 11, wherein:
the objects include processor environment independent smart cached objects.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture; and,
performing a dynamic workload management operation, the dynamic workload management operation managing a workload executing on the information handling system, the dynamic workload management operation being processor environment agnostic.

14. The non-transitory, computer-readable storage medium of claim 13, wherein:
the dynamic workload management operation includes a processor accelerator learning acceleration operation, the processor accelerator learning acceleration operation managing offloading of artificial intelligence workloads from a processor of the processor environment to a processor accelerator.

15. The non-transitory, computer-readable storage medium of claim 14, wherein:
the processor accelerator learning acceleration operation is context aware.

16. The non-transitory, computer-readable storage medium of claim 13, wherein:
the dynamic workload management operation includes a cache stack-based operation, the cache stack-based operation managing objects within a cache of the information handling system.

17. The non-transitory, computer-readable storage medium of claim 16, wherein:
the objects are associated with an artificial intelligence workload.

18. The non-transitory, computer-readable storage medium of claim 16, wherein:
the objects include processor environment independent smart cached objects.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
